(19) United States
(12) Patent Application Publication
(10) Pub. No.: US 2002/0145620 A1
(43) Pub. Date: Oct. 10, 2002

(54) Geographic information system for the management and retrieval of location-related drawings and other related electronic files

(76) Inventors: William Smith, Cranberry Township, PA (US); Bryan Maurer, Delmont, PA (US); Julie Shrum, Pittsburgh, PA (US)

Correspondence Address: KEVIN J. GARBER, ESQ., BABST CALLAND CLEMENTS & ZOMNIR, P.C., 8TH FLOOR, TWO GATEWAY CENTER, PITTSBURGH, PA, 15222, US

(21) Appl. No.: 10/118,539

(22) Filed: Apr. 8, 2002

Related U.S. Application Data
(60) Provisional application No. 60/282,613, filed on Apr. 9, 2001.

(51) Int. Cl. G09G 5/00; G06F 7/00; G06F 17/30

(52) U.S. Cl. 345/712; 707/3; 345/705

(57) ABSTRACT

This invention is a method and apparatus for managing drawings, documents, and data associated with the management of property and subunits within a property using a graphical user interface (GUI) and a geographic information system (GIS). The user inputs the property address and selected property and subunit management data into a relational computer database. This information is geocoded onto a map in order to locate the property and subunits on the map in relation to nearby geographic features. The geocoded map is then linked with the relational database so that a depiction of the geographic location of the property and associated information concerning that property can be displayed. The user may query the database to retrieve desired inputted property and subunit management data and view the results of that query on said map or in a table. The use of GIS to manage drawings, documents, and data in this fashion facilitates the ability to efficiently query and track this information spatially across subject properties, and subunits within those properties, within a region, state, country, or globally.

### CLAIM OF PRIORITY

This application claims the benefit of U.S. provisional application No. 60/282,613, with filing date of Apr. 9, 2002.

### TECHNICAL FIELD

The present invention is a method and apparatus, employing a software system and graphical user interface (GUI) for use by a plurality of users, for managing electronic drawings, documents, and data associated with a particular spatial location using a geographic information system (GIS). Drawings of facilities (such as office complexes, retail districts, shopping malls, industrial properties, and other developed and undeveloped properties) and other documents (such as summaries of lease terms, rentable space, etc) are converted to electronic format through scanning and are associated, in an electronic database, with a particular physical location or a sublocation within the facility. A screen, typically a computer screen, provides the user with menus of icons for various functions and displays a map of all the subject locations in the user's service region. Selection of a location (or querying of all locations) displays a highlighted map and associated data for the selected property or subunit within the property (or results of the query). The use of GIS to manage drawings and data in this fashion facilitates the ability to efficiently query, track, and map this information spatially across subject properties, and subunits within those properties, within a region, state, country, or globally.

### BACKGROUND OF THE INVENTION

The present invention relates generally to facilities management, geographic information systems (GIS), and graphical user interfaces (GUIs), and in particular to efficiently managing, on a spatial basis, facility drawings and information across a plurality of locations.

Commercial, institutional, governmental, medical, retail, and office property owners, managers, and their agents need to track and manage facility drawings and related information (such as the lease term, lease rate, contract rights and obligations, to name a few) with respect to many different buildings and facilities that are located at different locations throughout their service region, the state or country, or globally. Managing facilities involves keeping track of hundreds or thousands of engineering drawings (i.e., site plans, utilities, lease plans, architectural, mechanical, electrical, HVAC, plumbing, and others), photos, leases and other documents, and other information for the various properties that are managed or owned.

The current state of the art is to (1) maintain physical files of paper drawings, photos, and documents related to each property and each separate space within each property and to manually locate and copy a desired drawing or document each time information on said drawing or document is needed. This results in inefficient use of personnel time and lengthy delays while a particular drawing or document is located or information is manually tabulated; (2) retain a consultant or architect to manage the facility drawings. This results in increased cost to the owner or manager of a property; (3) use an in-house computer aided design (CAD) system to maintain facility drawings. This requires specialized training in CAD software; or (4) use sophisticated facilities management software. This is generally costly and does not have mapping capabilities.

GIS, GUIs, and facilities management are known in the art. However, the current art does not have a software system and GUI specifically for facilities management using GIS as the management tool. This invention provides the location owner, manager, or their agent, among other functions, the ability to show all locations being managed on a map, to display the results of queries on the maps, and to graphically drill down through various locations by selecting a location or sub-location on a map to obtain, view, and print information desired on a specific location or sub-location, or across multiple locations.

To solve the problem of quickly accessing information, drawings, and other files related to a specific property or subunit within a property, we developed a geographic information system and a method for using this system that allows the user to efficiently set up an electronic information database, and then subsequently retrieve the information in the database and view electronic versions of the desired drawings or files for a specific location or sub-location through the use of mapping in a graphical interface. It is a further object of the present invention to allow the user to perform querying and reporting functions on the information contained in the information database, based on criteria defined by the user.

We employed the following steps to accomplish the objects of the present invention. First, we developed an information database structure that includes information related to each property or subunit within a property, along with references to the disk locations of drawings and other pertinent electronic files related to each property or subunit. The nature of the information, drawings, and other pertinent electronic files depends on the nature of the desired embodiment of the invention.

Second, we developed a GUI to provide the user with a graphical means of viewing and modifying the information contained in the information database, and viewing, adding, and deleting drawings and other pertinent electronic files referenced in the information database. The graphical means include the use of location maps to browse through the desired information. The GUI was developed to also provide the user with a means of performing querying and reporting on the information contained in the database.

The specific steps employed in using this invention include (1) inputting information, drawings, documents, and other pertinent files related to one or more properties and subunits within a property into the database by appropriate means, including but not limited to scanning of paper documents, conversion of electronic documents, and manual data entry; (2) geocoding said property address onto a geocoded map using either automatic or manual placement methods; (3) assigning, in the relational database, specific locations for subunits within the property, (4) building a geographic information system by linking the relational database and specific records in the database to specific geocoded locations within the map, in part by creating polygons on a map representing specific subunits at each geocoded property; (5) displaying a depiction of the geographic location of the property on a map and data concerning the property from the relational information database; (6) querying the displayed depiction of the property to retrieve desired inputted information, including drawings, documents, and relevant property management data, and (7) viewing and modifying the information in the database and viewing, adding, and deleting drawings and other electronic files referenced in the database, by clicking on specific locations on the maps. Querying and reporting functions can also be performed on information contained in the database.

### SUMMARY OF THE INVENTION

This invention is a method and apparatus for managing drawings, documents, and data associated with the management of property and subunits within a property using a graphical user interface and a geographic information system. The method comprises the steps of inputting the property address, and selected property and subunit management data, into a relational computer database; geocoding said property address onto a geocoded map in order to locate said property and subunits on said map; assigning, in said relational database, specific locations for subunits within said property; building a geographic information system by linking said relational database with said geocoded map; displaying a depiction of the geographic location of said property on a map and data concerning the property from the relational information database; querying said displayed depiction to retrieve desired inputted property and subunit management data from said relational database; and viewing the results of the query.

### BRIEF DESCRIPTION OF THE DRAWINGS

FIG. 1 illustrates the general structure and relationship of the invention components.

FIG. 2 is a flow diagram illustrating the general logic of the information system.

FIG. 3 illustrates the first-level view of the GUI, displaying a national or regional map of all locations contained in the information database.

FIG. 4 illustrates the first-level view of the GUI, similar to FIG. 3, but zoomed in to a map of locations in a region of interest, along with information related to properties within the selected view.

FIG. 5 illustrates the first-level view of the GUI, similar to FIG. 4, but zoomed in further to show street-level detail in a region of interest, along with information related to a selected property.

FIG. 6 illustrates the second-level view of the GUI, on which the selected tab provides basic information related to a selected property.

FIG. 7 illustrates the second-level view of the GUI, similar to that of FIG. 5, but wherein a different property-level tab has been selected to display a list of subunits at the selected property and related information and data.

FIG. 8 illustrates the second-level view of the GUI, similar to that of FIG. 5, but wherein a different property-level tab has been selected to display a specific drawing related to the property, in this case, a property lease plan depicting the physical locations of subunits at the selected property.

FIG. 9 illustrates the third-level view of the GUI, on which the selected tab provides basic information related to a selected subunit.

FIG. 10 illustrates the third-level view of the GUI, similar to that of FIG. 9, but wherein a different sub-unit level tab has been selected to display a list of specific types of files related to the sub-unit, in this case, architectural drawings. The selected file is depicted in the bottom portion of the display.

FIG. 11 illustrates the first step of the query view of the GUI, wherein the user can select one, many, or all properties to query.

FIG. 12 illustrates the second step of the query view of the GUI, wherein the user can specify the desired query criterion or criteria. Subsequent steps allow the user to specify how results of the query are displayed.

### DETAILED DESCRIPTION OF THE INVENTION

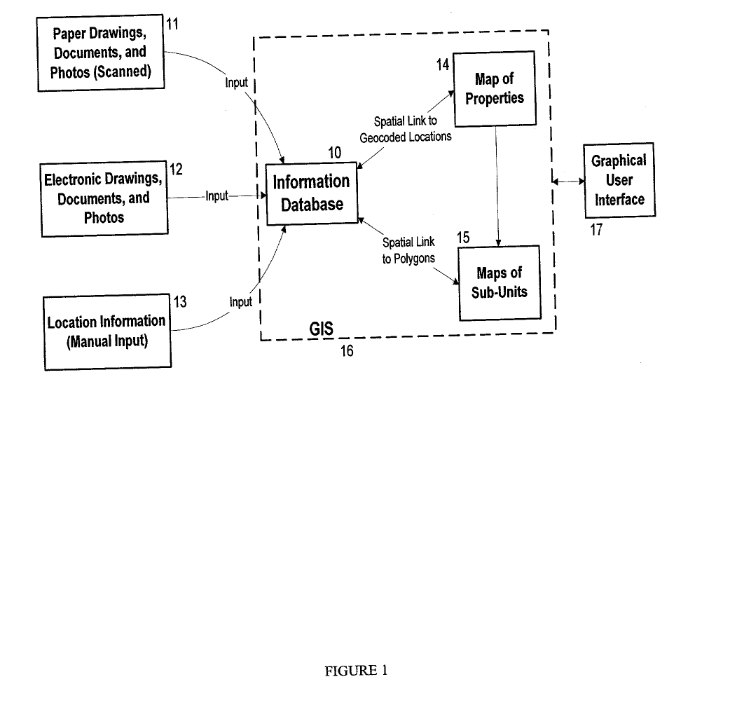

One embodiment of the present invention is a GUI software application developed for use by retail property managers. FIGS. 1 through 12 illustrate the structure, logic, and components of this application to manage information and electronic files related to one or more retail properties. This is one, but is not an exclusive, embodiment of the present invention.

In this embodiment, we developed a database file structure with a Java-based GUI to allow the user to access the information contained and referenced in the database files, as shown in the flowchart on FIG. 1 and as described in detail herein. The database file structure comprises four general categories of information: property files containing a unique site identification, file name and user identification; data files containing relevant data about each property as a whole such as its latitude and longitude, street address, city location, total square footage, owner and management contacts, property valuations, and the like; tenants files containing relevant data about subunits within each property such as tenant names, lease start and end dates, contact phone numbers, total square footage and rentable square footage, leased space, merchandising categories, sales data, and the like; and history files containing transaction dates, user space identifications, and similar data. More or fewer categories of information may be used as desired. Note that although a Java-based GUI has been developed for this embodiment, the GUI could be developed using any programming method known in the art.

The database files identified above are then used to develop relational information database 10, as shown in FIG. 1. This database is developed and populated by inputting desired property management data, which typically comprises various engineering drawings, such as those relating to floor plans, electrical systems, heating, venting and air conditioning (HVAC), and similar drawings, photographs, demographics data, and commercial/leasing documents and data, such as lease term, lease rate, lease assignability, square footage leased, and similar information. These data can exist in either a paper or electronic format. In FIG. 1, paper drawings, documents and photographs 11 are scanned into an electronic format and input into database 10. Existing electronic drawings, documents and photographs 12 are electronically transferred into information database 10. The property address and selected demographic, commercial, and leasing data 13 for the property and subunits within the property are manually input into information database 10. The object of this exercise is to populate information database 10 with the relevant information that a property manager needs to access to make informed management decisions.

Once information database 10 is developed, it is spatially linked to a geocoded map of properties 14. This is performed by assigning for each property in information database 10 a specific geographic location on the map of locations 14, based on the address information in database 10 for each property, using address geocoding procedures known in the art. This allows all of the information in database 10 related to a specific property to be linked to said property's assigned location on map 14.

For each property in database 10, a drawing of the property input into database 10 is used as a base for a map of sub-units 15. The user manually creates polygons on map of sub-units 15, each polygon depicting the geographic location of a specific sub-unit at said property. Each sub-unit in information database 10 is assigned by the user to a specific polygon on map 15, allowing all of the information in database 10 related to a specific sub-unit to be linked to said sub-unit's assigned polygon on map 15.

The information database 10, the map of properties 14, and the maps of sub-units 15 thus together comprise the GIS 16. A GUI 17 provides the user with a means for accessing, viewing, editing, and presenting information contained in said GIS 16.

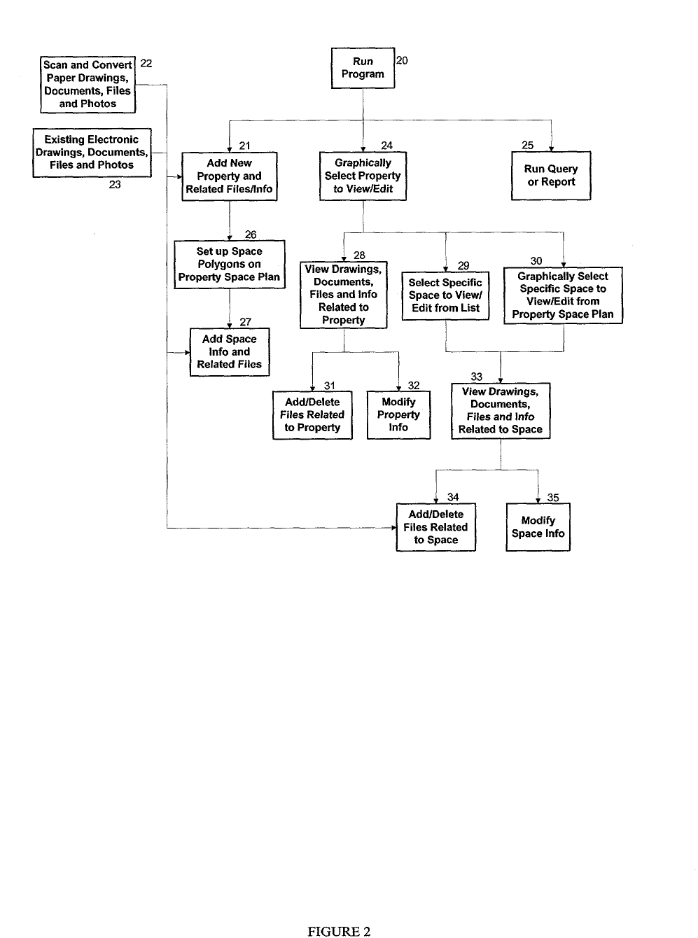

FIG. 2 illustrates the general logic of the information system. The user will run the program (box 20), and will have three options. One option is to input a new property and related information (box 21) into the information database 10 (FIG. 1). Information to be input can consist of scanned paper drawings, documents, and photos (box 22, box 11 on FIG. 1), previously existing electronic drawings, documents, and photos (box 23, box 12 on FIG. 1), and/or manually entered information (box 13 on FIG. 1) such as property address, general property data, contact information, and related information. The inputting of scanned or existing electronic drawings, documents, and photos is performed by entering computer file names into the information database 10 (FIG. 1).

The system will use the address information input by the user to assign to the new property a specific geographic location on map 14 of FIG. 1.

Upon inputting property information (box 21), the user can designate a drawing to be used as a property space plan and create polygons on said space plan geographically depicting sub-units at said property (box 26, box 15 on FIG. 1). The user then can input information related to each sub-unit, potentially including scanned paper drawings, documents, and photos (box 22, box 11 on FIG. 1), previously existing electronic drawings, documents, and photos (box 23, box 12 on FIG. 1), and/or manually entered information (box 13 on FIG. 1) such as general sub-unit data, contact information, sales data, and related information. The inputting of scanned or existing electronic drawings, documents, and photos is performed by entering computer file names into the information database 10 (FIG. 1).

A second option the user has upon running the program (box 20) is to use the GUI to select a specific property and view or edit information in the database 10 (FIG. 1) related to said property (box 24). Upon graphically selecting the property (box 24), the user can view drawings, documents, photos, and other information related to said property (box 28), and further add new drawings, documents, photos, or other information related to said property to the information database 110 (box 31), delete such information related to said property from the information database 110 (box 31), or modify such information related to said property in the information database 10 (box 32). Alternatively, the user can use the GUI to select a specific sub-unit at said property from either a list of sub-units at the property (box 29) or from the space plan for said property (box 30). In either case, upon selecting a specific sub-unit, the user can view drawings, documents, photos, and other information related to said sub-unit (box 33), and further add new drawings, documents, photos, or other information related to said sub-unit to the information database 10 (box 34), delete such information related to said sub-unit from the information database 10 (box 34), or modify such information related to said sub-unit in the information database 10 (box 35).

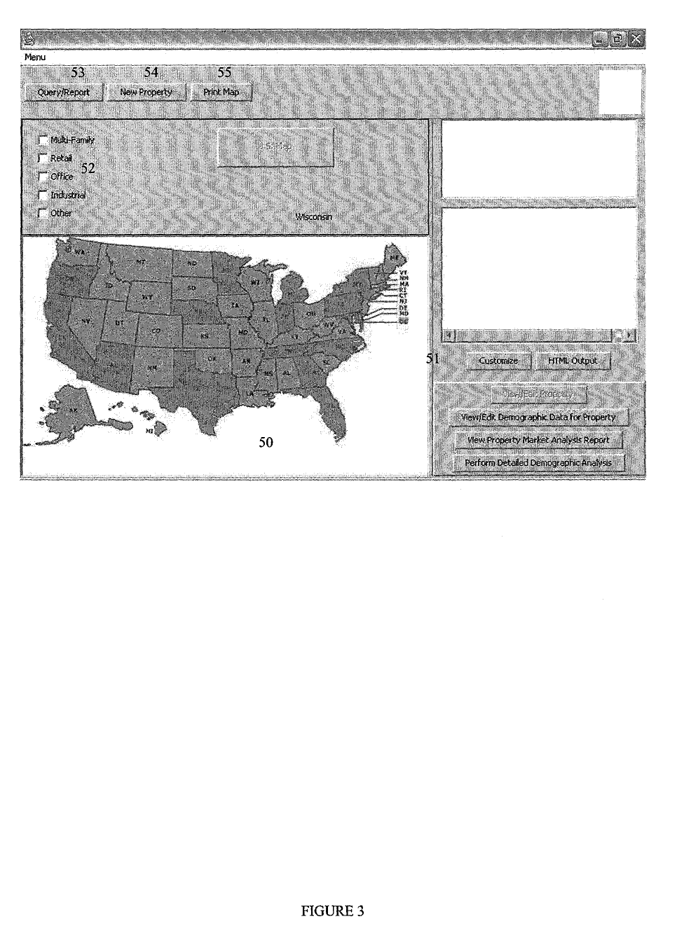

Upon running the application, the user is presented with a first-level view of the GUI, as illustrated on FIG. 3. The primary portion of this view will present a map of a specific geographic area, generally corresponding to the furthest extent of the properties previously entered into the database, or some other default geographic extent defined by the application if no properties are contained in the database. For this embodiment, the mapping is provided using licensed TIGER/Line geographic feature data to display political boundaries, selected highways and other geographic features. Alternately, the mapping could be provided using other geographic feature data sets, aerial photographs, or other sources of mapping data. Also displayed on the geographic map are the approximate locations of the properties previously entered into the database. In this embodiment, the property locations are mapped by geocoding the part or all of the address or the latitude and longitude entered in the database for the property, or manually selecting the property location by clicking on a specific location on the map.

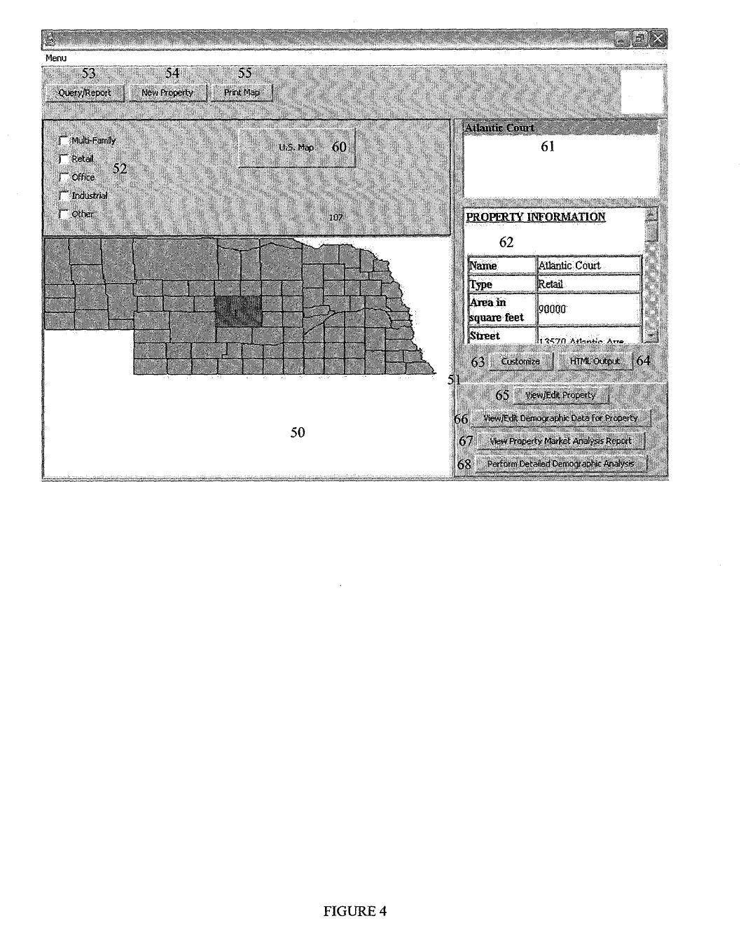

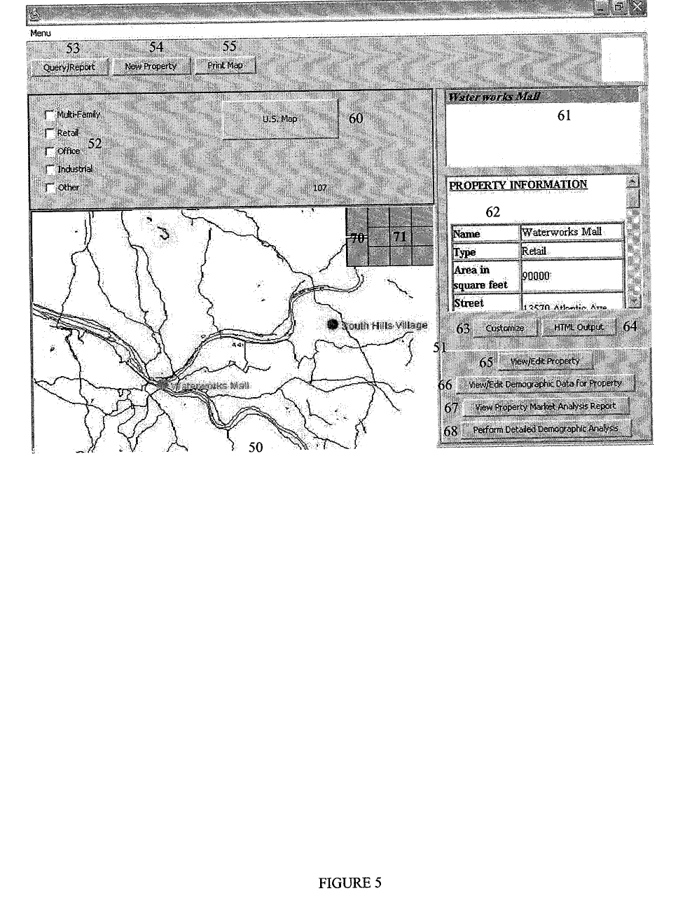

The user has several primary options from this view, as shown on FIG. 3. First, the user can manipulate the map view by clicking on the desired portion of map 50 in order to zoom in on said portion of map 50, providing a view such as that shown on FIG. 4. In alternative embodiments, this manipulation of map 50 can be performed using navigation buttons provided in the GUI to pan the map 50 display in eight directions or to zoom in or out (such an embodiment is depicted on FIG. 5). The user can also drag border 51 between the left and right portions of the view to allocate a different amount of space to each in the GUI. Second, the user can select one or more of the checkboxes 52 in order to specify which specific types of properties to be displayed on map 50. Third, the user can click button 54 on the GUI to add one or more new properties to the database (described below). Fourth, the user can click button 53 on the GUI to run a standard or custom query or report on the information contained in the database (described below). Fifth, the user can click button 55 on the GUI to print map 50. Additional options available to the user could include standard application tasks such as saving and defining default program characteristics

FIG. 4 depicts the first-level view of the GUI, similar to that depicted in FIG. 3, but wherein map 50 has been zoomed in to depict a specific region of interest. Border 51, checkboxes 52, and buttons 53, 54, and 55 on FIG. 4 are used in the same manner and perform the same function as described above for FIG. 3. The user can return to the initial default map view of FIG. 3 by clicking on button 60. By clicking on a specific area of map 50, the user can bring up a list 61 of properties located within the map 50 area clicked. By selecting one of the properties on list 61, the user display general information contained in the database related to said property in window 62. Clicking button 63 allows the user to select specific database information fields to be displayed in window 62. The user can create a printable view of the information in window 62 by clicking on button 64.

The user has several more options from the GUI presented in FIG. 4. First, by clicking button 65, the user can view or edit detailed information contained in the database related to the property selected in list 61, as described below. Second, the user can click on button 66 to view basic demographic data, such as age, income, household size, and other desired demographic data, entered into the database for said property. Third, the user can view specific documents related to said property, such as a market analysis report in this embodiment, by clicking on button 67. Note that said document could be an electronic document of any type created by any other software program. Fourth, the user can click button 68 to perform a custom, real-time detailed demographic analysis for said property, using demographic data provided with this program or obtained from third-party vendors of demographic data.

An alternate first-level view of the GUI is depicted on FIG. 5. In this embodiment, map 50 shows a street-level detailed map of the area of interest and locations of properties within the area of interest. When the user selects a specific property location on map 50, said property is placed in list 61, and general information related to said property is displayed in window 62. The user can click buttons 70 to zoom the view of map 50 in or out, or buttons 71 to pan the view in any of eight directions. GUI features 51 through 68 on FIG. 5 are used in the same manner and perform the same functions as described above for FIG. 4.

To add new properties to the database, from the first-level view (FIGS. 3, 4 and 5), the user can click button 54 on the GUI. In this embodiment, the user enters information related to a new property via a wizard-type interface, wherein the user is prompted for property information to be entered in the database, such as name, location, contact, financial, and other information. The application provides the property with a unique identifier. The user is then prompted to specify the disk locations of drawings (including a property space plan and other engineering drawings), photographs, and other pertinent electronic documents related to the property. In the present embodiment, file types which can be referenced in the database are limited to standard bitmap image types, such as TIFF, JPEG and BMP. In other embodiments, additional file types could be referenced, including document files (such as DOC), vector image files (such as WMF), and CAD files (such as DWG and DXF). These files can be created from existing paper documents using standard image scanning techniques, or from existing electronic documents using standard file conversion/export routines.

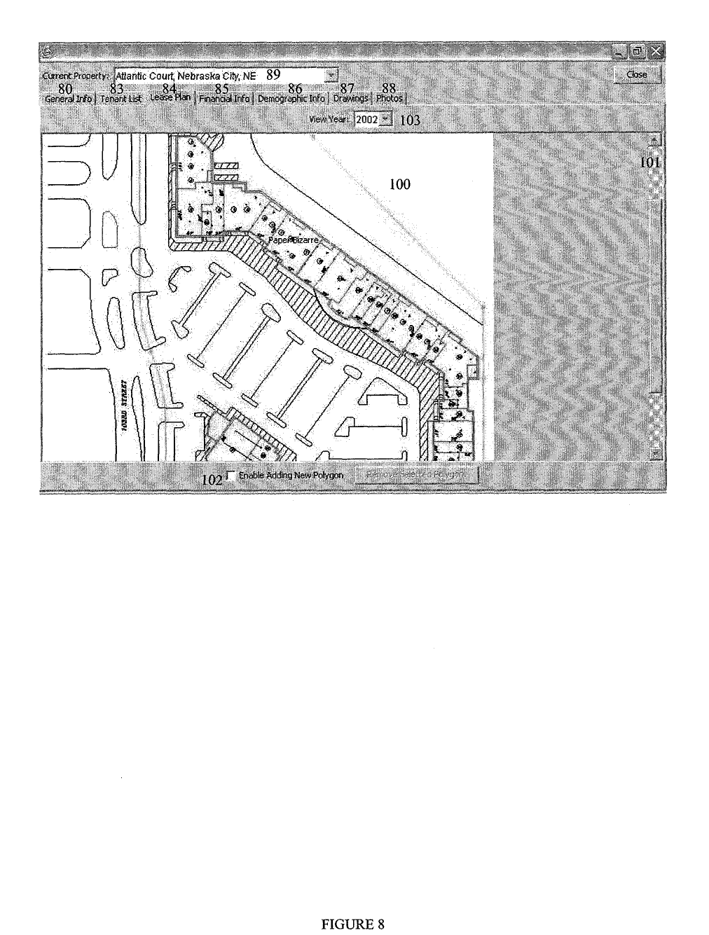

After this information is added, the user can utilize tools in the GUI to create polygons overlaying the property space plan (see discussion of FIG. 8 below). These polygons represent sub-property units, such as individual spaces or stores in the present embodiment as a retail property management system. After the polygons are drawn, the user is prompted for information related to each space to be entered in the database, such as name, classification, lease, contact, sales, and other information. The user is then prompted to specify the disk locations of drawings (including a space layout plan and other engineering drawings), photographs, and other pertinent electronic documents related to the space. The application provides the space with a unique identifier, automatically linking the space information with the polygon drawn on the property space plan.

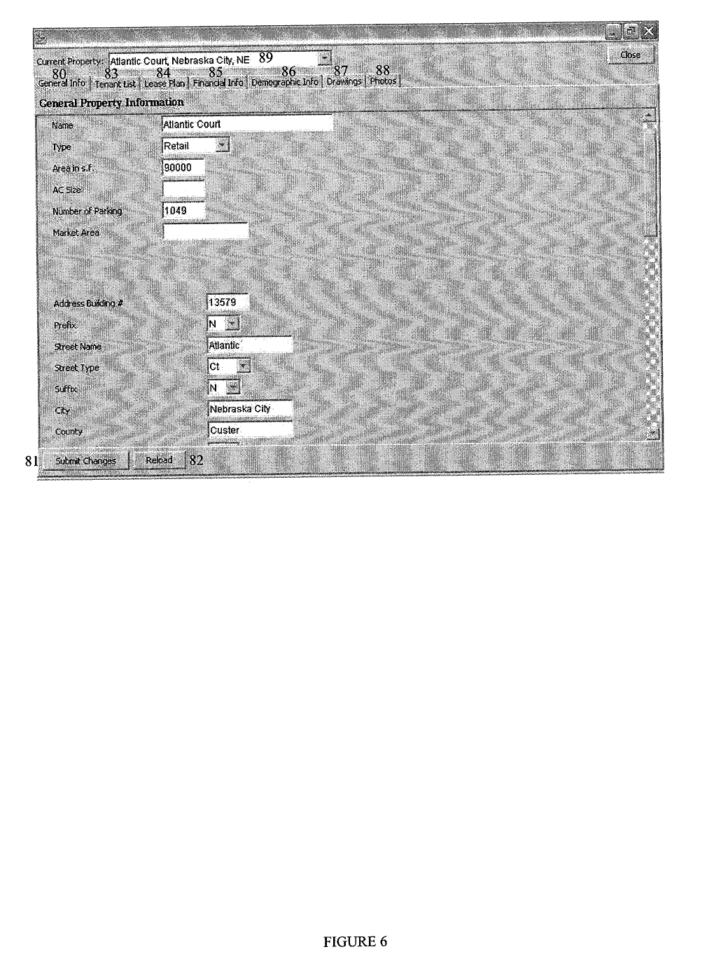

As illustrated on FIG. 4, the user can click on a specific property on the map and view basic information related to the selected property in window 62 on the right side of the GUI. If desired, the user can then click button 65 on the GUI to view the property in greater detail. Performing this action brings up a second-level view in the GUI, illustrated on FIG. 6.

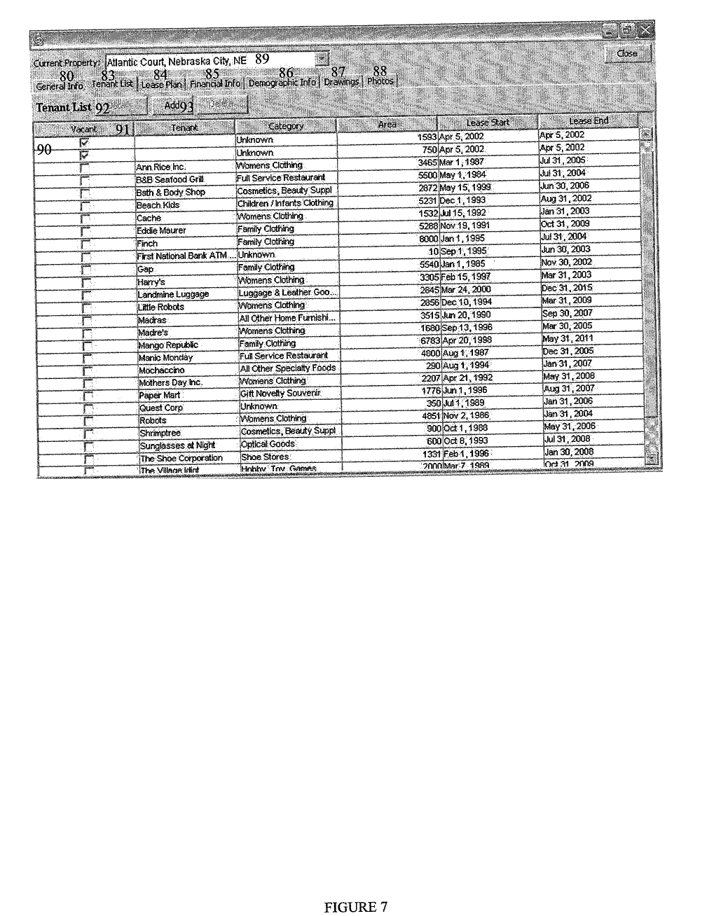

This second-level (FIG. 6) view contains specific information related to the selected property. Specifically, the second-level view contains several tabs, with each tab providing a different type of information. In this embodiment, one of these tabs, tab 80, provides the property information from the database, which the user can modify if necessary by typing revised information in the appropriate place and then clicking button 81. Modifications to the property information can be abandoned and the original information restored by clicking button 82. Tab 83 provides a listing of the individual spaces comprising the property (see discussion of FIG. 7 below), from which the user can select a specific space to view in greater detail (as discussed below). Tab 84 presents a property lease plan (see FIG. 8), with polygons representing the locations of each of the sub-units at the property. Tab 85 provides financial data contained in the database for the selected property, including, but not limited to, appraised property values, property-wide sales data, and other relevant financial data. Tab 86 provides basic demographic data for the property, similar to the data provided by clicking on button 66 of FIG. 4. Tab 87 provides a list of engineering and other electronic drawings and documents in the database for the selected property, as well as a window for viewing such drawings and documents and a means for adding drawings and documents to the list. Types of drawings and documents could include, but not be limited to, civil site plans, electrical, heating/ventilation/air conditioning (HVAC) and other mechanical, water/sewage services, and architectural. Tab 88 provides a list of electronic photographs in the database for the selected property, as well as a window for viewing such photographs and a means for entering additional photographs to the list. This is not an exhaustive list of tabs for available information. This embodiment simply uses this set of data as being among the most commonly used data by retail property managers. In addition to these tabs, the user can select a different property from box 89 to view the information in the database related to that property, without having to go back to the first-level GUI.

FIG. 7 depicts the second-level view of the GUI, but with tab 83 being displayed. From this tab, the user can view list 90 of each of the sub-units at the selected property, along with basic database information related to each sub-unit. Clicking on one of the column headers 91 automatically sorts list 90 in ascending or descending order for the header clicked. After selecting a specific sub-unit from list 90, the user can then click on button 92 to view specific details related to said sub-unit, as discussed below. The user can also click button 93 to bring up a dialog box which allows the user to enter information related to a new sub-unit at the property into the database.

FIG. 8 depicts the second-level view of the GUI, but with tab 84 being displayed. On this tab, the user can view the lease plan 100 for the selected property, using scroll bar 101 to pan the drawing. In another embodiment, buttons could be provided to allow the user to zoom in or out on the drawing, and/or to pan the drawing in any of eight directions. By checking box 102, the user is able to draw polygons on the lease plan 100 representing specific sub-units at the property. After drawing said polygon, the user is prompted to select the name of the sub-unit from the available names in the database for the property. The user can then click on a polygon drawn on lease plan 100 in order to view the detailed information related to the corresponding sub-unit, as described below. The user can also select a date from box 103 to view the configurations of the sub-unit polygons on the selected date. In another embodiment, the user could cycle through each previous change to the sub-unit polygon configurations, rather than specifying a date. Options can also be added for the user to perform other basic operations, such as exporting or printing the view.

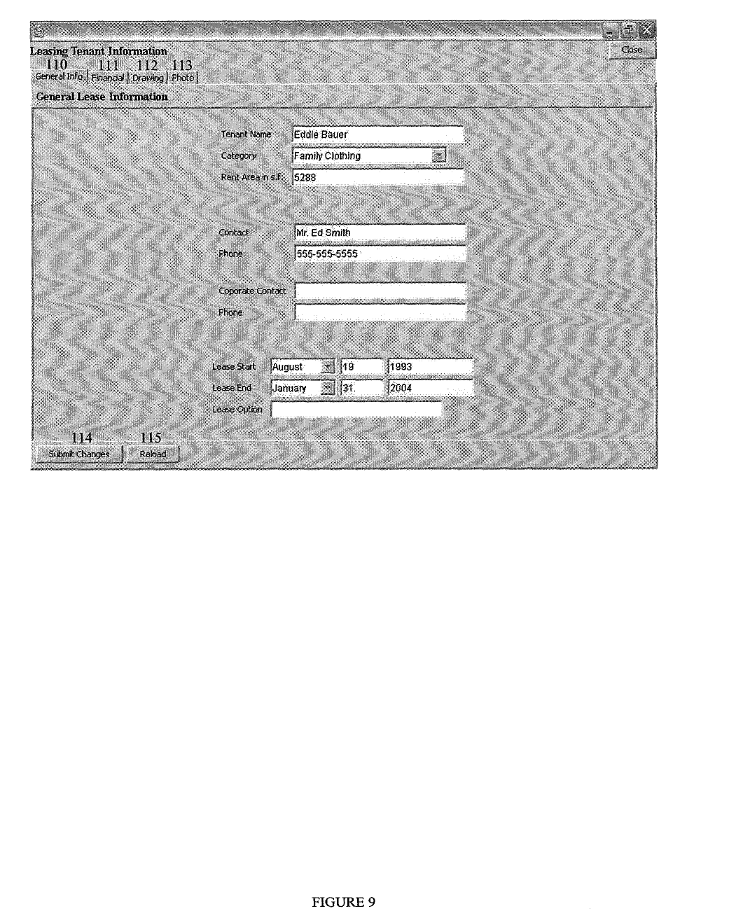

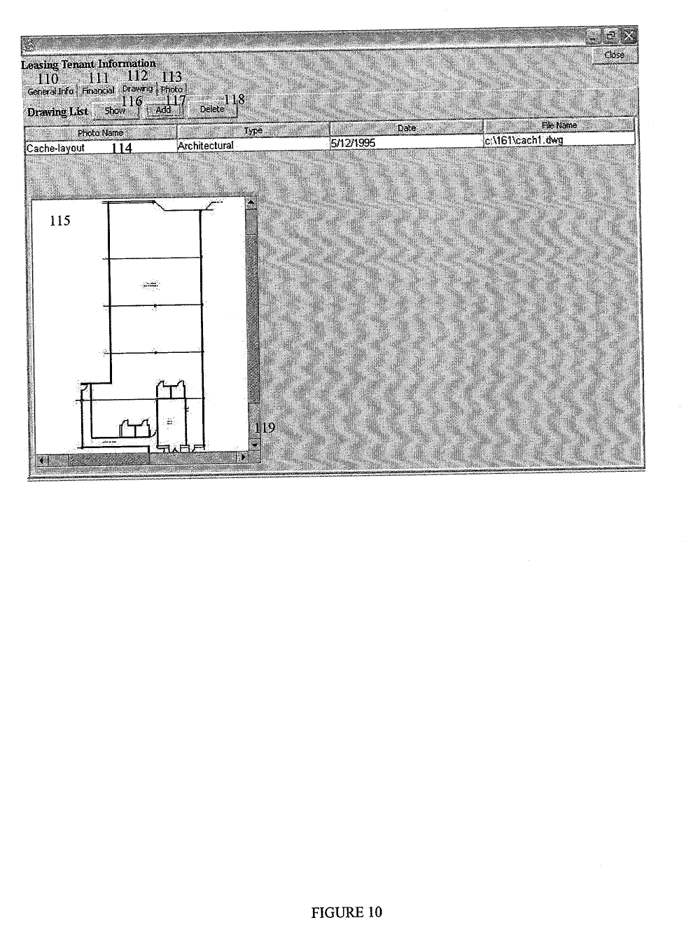

The user can select a specific space or subunit to view in greater detail, as shown in FIG. 9, or can access various types of engineering drawings, and photographs associated with that specific sub-unit, as shown in FIG. 10. As described above, two methods are provided in the present embodiment for accessing information for a specific sub-unit from the second-level view of the GUI. In the first method, the user can select the polygon corresponding to a specific sub-unit on the specific property's “Lease Plan” tab 84 (FIG. 8). In the second method, the user can select a specific sub-unit from the listing included on the specific property's “General Info” tab 80 (FIG. 7). Using either selection method, the detailed information related to the selected sub-unit is presented on a third-level view of the GUI, as illustrated on FIG. 9.

FIG. 9 illustrates the third-level view of the GUI, with tab 110 displaying the name, contacts, leasing, and other relevant information in the database for the selected sub-unit, which the user can modify if necessary by typing revised information in the appropriate place and then clicking button 114. Modifications to the sub-unit information can be abandoned and the original information restored by clicking button 115. Tab 111 provides financial data contained in the database for the selected sub-unit, including, but not limited to, lease rates, sub-unit sales data, and other relevant financial data. Tab 112 provides a list of engineering and other electronic drawings and documents in the database for the selected sub-unit, as well as a window for viewing such drawings and documents and a means for adding drawings and documents to the list. Types of drawings and documents could include, but not be limited to, electrical, HVAC and other mechanical, water/sewage services, and architectural. Tab 113 provides a list of electronic photographs in the database for the selected sub-unit, as well as a window for viewing such photographs and a means for entering additional photographs to the list. FIG. 10 shows the third-level view of the GUI, but with tab 112 displayed to show list 114 of electronic drawings and documents in the database related to the selected sub-unit. From this tab, the user can select a drawing or document from list 114, and then click button 1 16 to have the drawing or document displayed in window 115. The user can pan the drawing in window 11 5 using scroll bars 119, or in another embodiment, use navigation buttons to zoom in or out or to pan the drawing. In addition, the user can click button 117 to add other electronic drawings or documents to the list, or button 118 to delete drawings or documents from the list. Options can also be added for the user to perform other basic operations, such as exporting or printing the drawings and documents.

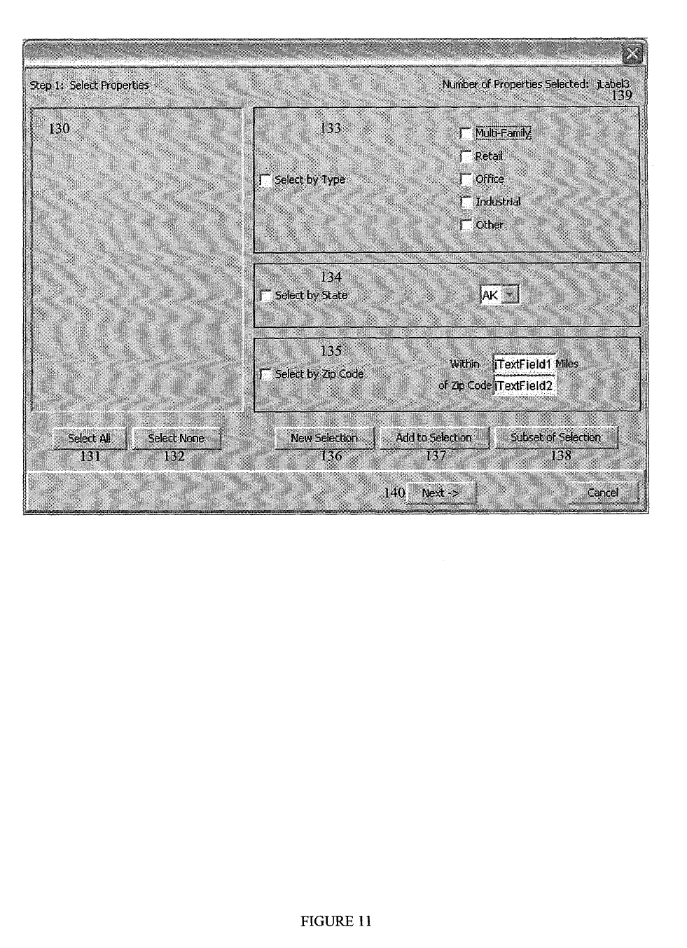

From the first-level view of the GUI, the user can run a standard query to indentify properties or sub-units meeting specific criteria, or a report of specific data related to certain properties or sub-units, by clicking button 53 on the GUI, bringing up a query/report wizard, the first step of which is illustrated in FIG. 11.

In running a query or report, the user would first select the properties to be subject to the query or report in window 130 of FIG. 11. The user could select one or multiple properties by manually selecting properties from window 130, or select all properties to be included in the query or report by clicking button 131. Clicking button 132 would clear the properties selected for the query or report. Alternatively, the user could select properties to be subject to the query or report by selecting specific types of properties to be included (box 133), or a specific geographic location(s) for properties to be included (box 134 and 135). After the user specifies criteria in box 133, 134, or 135, the user can click either box 136 to have previous property selections cleared and replaced by those meeting the newly defined criteria, box 137 to have those properties meeting the new criteria added to those properties previously selected, or box 138 to include only those properties previously selected and meeting the newly defined criteria. As selections are made, the number of properties within the current selection set is displayed at label 139. The user then clicks box 140 to proceed to the second step of the query/report wizard.

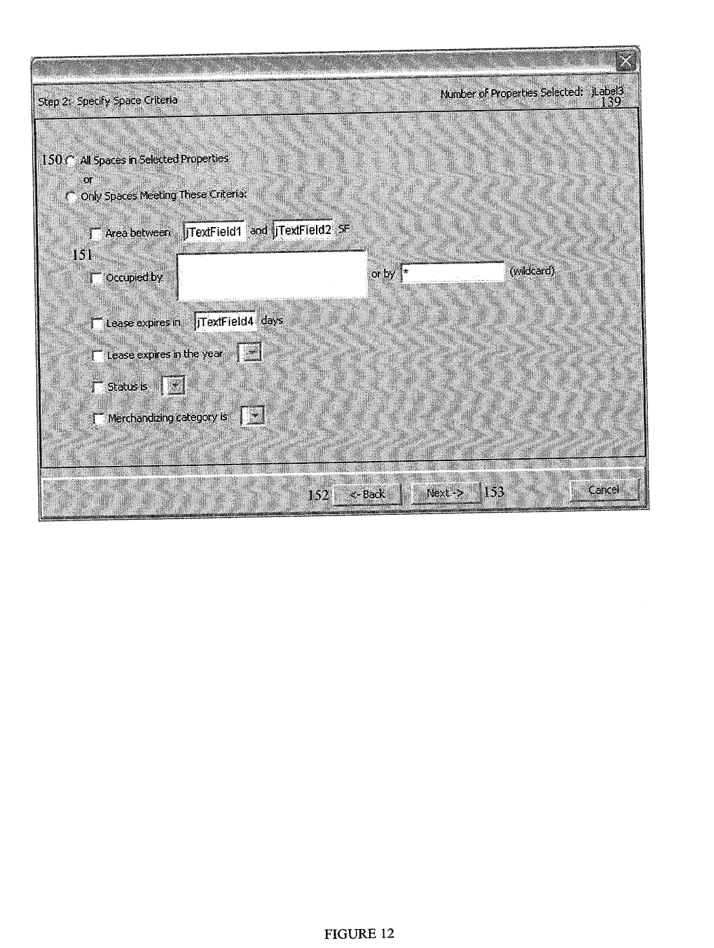

In step two of the query/report wizard, the user can specify criteria for sub-units at the selected properties, as shown on FIG. 12. The user can include all sub-units at each of the properties in the current selection set by clicking box 150. Alternatively, the user can use boxes 151 to specify certain criteria to be used in determining which sub-units at the selected properties are included in the results of the query or report. In the present embodiment, the criteria available for the query are based on the fields available in the database for each space. The user then clicks button 152 on the GUI to return to the first step (selecting specific properties to be included in the query or report), or button 153 to continue the query or report. Subsequent steps in the query/report wizard allow the user to define how results of the query or report are displayed, and also allow the user to save or print the results of the query or report. As a result of a typical query, each of the properties which contain a space which meets the query criteria is highlighted on the first-level map view. Further, each space which meets the query criteria is highlighted on the “Info” and “Plan” tabs in the second-level view for the corresponding properties. As a result of a typical report, a text file is generated containing specific information related to the specified spaces or properties.

Although the embodiment of the present invention described herein involves retail property management and the tracking of engineering drawings, photographs, and other associated documents, the present invention is readily applicable to any type of property management, including, but not necessarily limited to commercial, institutional, governmental, medical, and office property management, or any other type of property management that involves the tracking of any type of drawings, photographs, and other information related to the properties that are managed or owned. These other embodiments can be achieved by making minor changes to the database information, such as modifying field names to suit the desired embodiment, along with the associated changes to the GUI accessing the information contained in the database.

Also, the present invention can use a variety of hardware environments. For example, although the invention has to date been used only on stand-alone computers, the invention may also be used on computer networks, including wireless networks and the internet, or in other computer architecture configurations, or on other types of programmable equipment.

The embodiment described herein is merely illustrative of the principles of this invention. Other arrangements and advantages may be devised by those skilled in the art without departing from the spirit and scope of the invention. Accordingly, the invention should be deemed not to be limited to the above-detailed description but only by the spirit and scope of the claims, and their equivalents.

Throughout the specification and the claims, for ease and clarity of description, point-and-click mouse driven GUIs are discussed. The present invention may also include GUIs with other techniques of selection, such as touch screens, light pens, cursor controls, track-ball devices, voice recognition selection techniques, or other techniques. Each of these elements are means for indicating and activating functions that are graphically interfaced to the user on the GUI. Functions that may be activated may be indicated by icons, graphic representations of buttons, user bars, menus, display boxes, text, or otherwise.

What is claimed is:

1. A method for managing drawings and data associated with the management of property and subunits within a property using a graphical user interface and a geographic information system, comprising the steps of:
inputting the property address, and selected property and subunit management data, into a relational information database;
geocoding said property address onto a geocoded map in order to locate said property and subunits on said map;
assigning, in said relational information database, specific locations for subunits within said property;
building a geographic information system by linking said relational information database with said geocoded map;
displaying a depiction of the geographic location of said property on a map and data concerning said property from said relational information database;
displaying a list of properties within a geographic boundary on said map;
querying said displayed depiction to retrieve desired inputted property and subunit management data from said relational information database; and
viewing the results of said query.

2. The method for managing drawings and data set forth in claim 1 wherein said step of inputting selected property and subunit management data further comprises inputting one or more of commercial data, lease terms, engineering drawings, text and electronic documents, and photographs for said property and subunit.

3. The method for managing drawings and data set forth in claim 1 wherein said step of inputting selected property and subunit management data further comprises inputting said data manually or electronically.

4. The method for managing drawings and data set forth in claim 1 wherein said step of querying the displayed depiction further comprises reporting desired property and subunit management data from said relational information database.

5. The method for managing drawings and data set forth in claim 1 wherein said step of geocoding further comprises geocoding the property latitude and longitude of the property to locate the property on said map.

6. The method for managing drawings and data set forth in claim 1 wherein said step of displaying a depiction of the geographic location of said property and data concerning said property from said relational information database further comprises displaying said property in relation to a specific geographic area defined by other properties entered into said relational information database.

7. The method for managing drawings and data set forth in claim 1 wherein said step of displaying a depiction of the geographic location of said property and data concerning said property from said relational information database further comprises displaying subunits within said property.

8. The method for managing drawings and data set forth in claim 1 wherein said step of displaying a depiction of the geographic location of said property and data concerning said property from said relational information database further comprises displaying a list of properties within a selected geographic boundary.

9. The method for managing drawings and data set forth in claim 1 wherein said step of querying said displayed depiction further comprises inputting specific commands to retrieve desired data from said relational information database.

10. The method for managing drawings and data set forth in claim 1 wherein said step of querying said displayed depiction further comprises modifying, adding, and deleting property and subunit management data from said relational information database.

11. The method for managing drawings and data set forth in claim 1 wherein said step of viewing the results of said query further comprises viewing a subunit within a property.

12. The method for managing drawings and data set forth in claim 1 wherein said step of viewing the results of said query further comprises viewing specific selected property and subunit management data within said relational information database.

13. The method for managing drawings and data set forth in claim 12 wherein said specific selected property and subunit management data within said relational information database are color-coded based on criteria defined in said query.

14. Apparatus for managing drawings and data associated with the management of property and subunits within a property using a graphical user interface and a geographic information system, comprising
means for inputting the property address, and selected property and subunit management data, into a relational computer database;
means for geocoding said property address onto a geocoded map in order to locate said property and subunits on said map;
means for assigning, in said relational database, specific locations for subunits within said property;
means for building a geographic information system by linking said relational database with said geocoded map;
means for displaying a depiction of the geographic location of said property on a map and data concerning said property from said relational information database;
means for querying said displayed depiction to retrieve desired inputted property and subunit management data from said relational database; and
means for viewing the results of said query.

15. The apparatus for managing drawings and data set forth in claim 14 wherein said means for inputting selected property and subunit management data further comprises means for inputting one or more of commercial data, lease terms, engineering drawings, text and electronic documents, and photographs for said property and subunit.

16. The apparatus for managing drawings and data set forth in claim 14 wherein said means for geocoding further comprises means for geocoding the property latitude and longitude of the property to locate the property on said map.

17. The apparatus for managing drawings and data set forth in claim 14 wherein said means for displaying a depiction of the geographic location of said property and data concerning said property from said relational information database further comprises means for displaying subunits within said property.

18. The apparatus for managing drawings and data set forth in claim 14 wherein said means for querying said displayed depiction further comprises means for inputting specific commands to retrieve desired data from said relational information database.

19. The apparatus for managing drawings and data set forth in claim 14 wherein said means for querying said displayed depiction further comprises means for modifying, adding, and deleting property and subunit management data from said relational information database.

20. The apparatus for managing drawings and data set forth in claim 14 wherein said means for displaying a depiction of the geographic location of said property and data concerning said property from said relational information database further comprises means for displaying said property in relation to a specific geographic area defined by other properties entered into said relational information database.

21. The apparatus for managing drawings and data set forth in claim 14 wherein said means for displaying a depiction of the geographic location of said property and data concerning said property from said relational information database further comprises means for displaying a list of properties within a selected geographic boundary.

22. The apparatus for managing drawings and data set forth in claim 14 wherein said means for viewing the results of said query further comprises means for viewing specific selected property and subunit management data within said relational information database.

23. The apparatus for managing drawings and data set forth in claim 22 wherein said specific selected property and subunit management data within said relational information database are color-coded based on criteria defined in said query.
